(19) United States
(12) Patent Application Publication
(10) Pub. No.: US 2005/0105154 A1
(43) Pub. Date: May 19, 2005

(54) Scanning apparatus using light modulator

(76) Inventors: Sang Kyeong Yun, Kyunggi-do (KR); Dong-Ho Shin, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/951,274

(22) Filed: Sep. 27, 2004

(30) Foreign Application Priority Data
Nov. 3, 2003 (KR) 2003-77391

(51) Int. Cl. G02B 26/08

(52) U.S. Cl. 359/198

(57) ABSTRACT

The present invention relates to a scanning apparatus using a light modulator. The scanning apparatus simultaneously and horizontally scans a plurality of diffracted beams, formed by actuating cells turned on/off in response to externally applied drive power, onto a photosensitive member. The scanning apparatus includes a first lens unit for converting a single beam, emitted from a light source, into collimated light, and emitting the collimated light. A light modulation means includes a plurality of actuating cells turned on/off by drive power, and diffracts and modulates the single beam to form a plurality of diffracted beams by on/off operation of the actuating cells. A filtering means selectively allows diffracted beams having at least one predetermined diffraction coefficient, among the plurality of diffracted beams formed by the light modulation means, to pass therethrough. A second lens unit focuses the plurality of diffracted beams selectively passing through the filtering means onto a photosensitive member.

### BACKGROUND OF THE INVENTION

1. Field of the Invention

The present invention relates, in general, to scanning apparatuses using a light modulator and, more particularly, to a scanning apparatus using a light modulator, which allows a plurality of diffracted beams formed by actuating cells turned on/off in response to drive power, to be horizontally incident on a photosensitive member, thus performing high speed scanning.

Further, the present invention relates to a scanning apparatus using a light modulator, which can perform true grayscale control of adjusting the intensity of diffracted beams in an analog manner on the basis of the level of step height formed between actuating cells varying with the strength of externally applied drive power.

2. Description of the Related Art

Printer technology has been developed toward high speed, miniaturization, high quality and low cost. Typical printers employ a laser scanning scheme of scanning laser beams using a Laser Diode (LD) and an f-θ lens. In order to realize a high speed printer, an image head scheme using a multibeam type beam generation device is used. In such a scheme, high speed and high quality characteristics can be realized, but the cost increases due to the use of a plurality of light sources.

FIG. 1 illustrates an example in which a conventional laser scanning scheme using a single light source and an f-θ lens is used. As shown in FIG. 1, an example of the operation of the laser scanning scheme is described below. If a light beam is generated by a Laser Diode (LD) 10 in response to a video signal and passes through a collimator lens 20, the light beam is converted into collimated light. The collimated light is converted into linear light parallel to a scanning direction by a cylindrical lens 30, and the linear light is incident on a polygon mirror 40.

As described above, if the linear light parallel to the scanning direction is transmitted by the cylindrical lens 30, the polygon mirror 40, rotated by a motor, scans the incident linear light in the direction of an f-θ lens 50.

Thereafter, the linear light scanned at a constant angular velocity by the polygon mirror 40 is deflected by the f-θ lens 50 in a scanning direction, the aberration of the deflected linear light is corrected, and the corrected light is scanned onto the scanning surface of a photosensitive drum 60 at a uniform velocity.

In the laser scanning scheme, it is difficult to attain a high printing speed due to problems related to the low switching speed of the laser diode 10 and the scanning speed of the polygon mirror 40.

That is, in order to increase the scanning speed of light beams, the polygon mirror 40 must be rotated using a higher speed motor. However, the higher speed motor is expensive, and the motor rotating at high speed causes heat, vibration and noise to incur problems such as the deterioration of operating reliability, so that a great improvement in scanning speed cannot be expected.

In another method of increasing the speed of an optical scanning apparatus, there is an image head printing scheme using a multibeam type beam generation device.

That is, as shown in FIG. 2, an array 80 of many Light Emitting Diodes (LEDs), the number of which is sufficient to fill a printing paper, is constructed in an image head 70 to form a plurality of beams, so that one line can be simultaneously printed without using a polygon mirror and an f-θ lens, unlike the laser scanning scheme, thus markedly increasing printing speed.

However, if a plurality of LEDs is used so as to construct the LED array 80, the cost increases, and light uniformity between LEDs in the array is decreased, so that it is difficult to obtain uniform images.

### SUMMARY OF THE INVENTION

Accordingly, the present invention has been made keeping in mind the above problems occurring in the prior art, and an object of the present invention is to provide a scanning apparatus using a light modulator, which allows a plurality of diffracted beams, formed by actuating cells turned on/off in response to drive power, to be horizontally incident on a photosensitive member, thus performing high speed scanning.

Another object of the present invention is to provide a scanning apparatus using a light modulator, which can perform true grayscale control of adjusting the intensity of diffracted beams in an analog manner on the basis of the level of step height formed between actuating cells varying with the strength of externally applied drive power.

In order to accomplish the above objects, the present invention provides a scanning apparatus using a light modulator, comprising a first lens unit for converting a single beam, emitted from a light source, into collimated light, and emitting the collimated light; light modulation means including a plurality of actuating cells turned on/off by drive power, the light modulation means diffracting and modulating the single beam to form a plurality of diffracted beams by on/off operation of the actuating cells; filtering means for selectively allowing diffracted beams having at least one predetermined diffraction coefficient, among the plurality of diffracted beams formed by the light modulation means, to pass therethrough; and a second lens unit for focusing the plurality of diffracted beams selectively passing through the filtering means onto a photosensitive member, wherein the light modulation means is placed on the same horizontal plane as the photosensitive member to simultaneously and horizontally scan the plurality of diffracted beams onto the photosensitive member.

Preferably, the scanning apparatus may comprise a beam splitter for transmitting the single beam incident through the first lens unit in a direction of the light modulation means, and transmitting the plurality of diffracted beams formed by the light modulation means in a direction of the photosensitive member.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a conventional laser scanning scheme using a single light source and an f-θ lens;

FIG. 2 is a view showing a conventional laser scanning scheme of performing laser scanning using a plurality of beams formed by an array of LEDs constructed in an image head;

FIG. 3 is a view showing a scanning apparatus for performing high speed scanning using a light modulator according to a first embodiment of the present invention;

FIG. 4 is a view showing a scanning apparatus for performing high speed scanning using a light modulator according to a second embodiment of the present invention;

FIG. 5 is a view showing a scanning apparatus for performing high speed scanning using a light modulator according to a third embodiment of the present invention;

FIG. 6 is a view showing a scanning apparatus for performing high speed scanning using a light modulator according to a fourth embodiment of the present invention;

FIGS. 7a and 7b are sectional views showing the construction of a light modulation means including a plurality of actuating cells according to the present invention;

FIGS. 8a and 8b are views showing a one-dimensional array and a two-dimensional array, respectively, of actuating cells constituting the light modulation means according to the present invention;

FIGS. 9a and 9b are views showing the operation of the light modulation means operating in response to a condition where drive power is not applied, according to the present invention; and

FIGS. 10a and 10b are views showing the operation of the light modulation means operating in response to a condition where drive power is applied, according to the present invention.

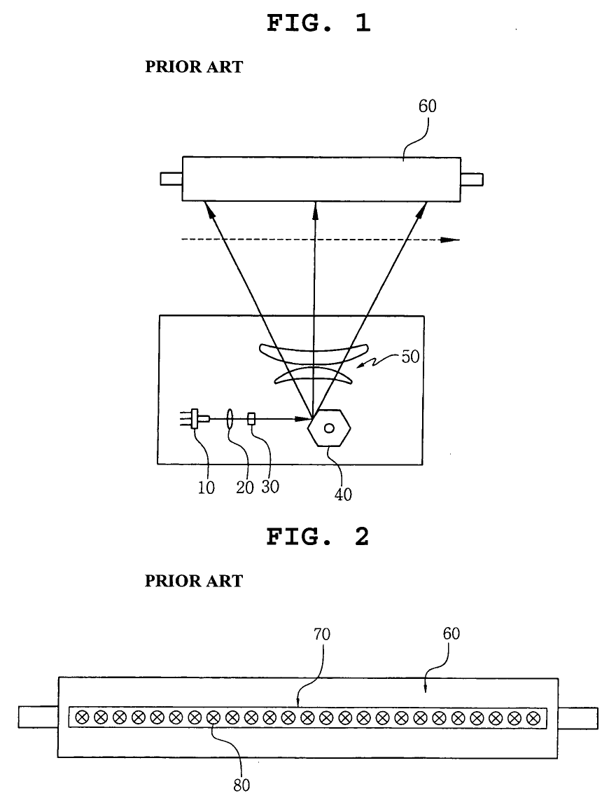

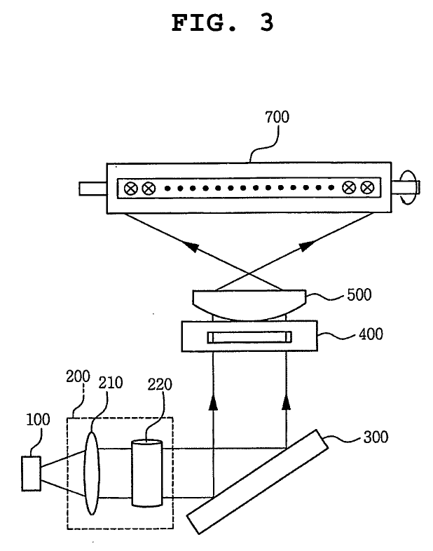

### DESCRIPTION OF THE PREFERRED EMBODIMENTS

Hereinafter, the construction of a scanning apparatus using a light modulator according to embodiments of the present invention will be described in detail with reference to the attached drawings.

With reference to FIGS. 3 to 6, the construction of the scanning apparatus using a light modulator according to the present invention is described in detail.

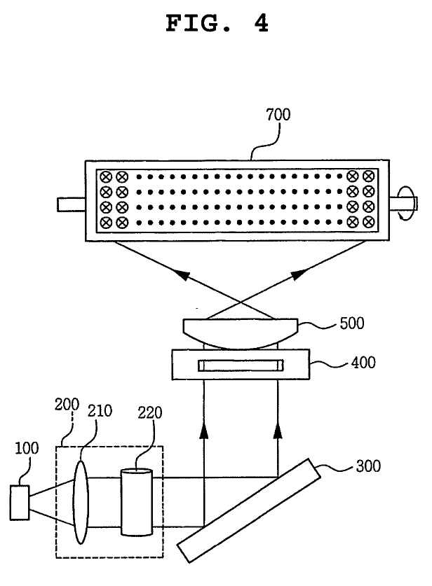

The scanning apparatus using a light modulator of the present invention horizontally scans a plurality of diffracted beams, formed by the light modulator including a plurality of actuating cells that is turned on/off by drive power, onto a photosensitive member, thus performing high speed scanning. As shown in FIGS. 3 and 4, the scanning apparatus includes a light source 100, a first lens unit 200, a light modulation means 300, a filtering means 400, and a second lens unit 500.

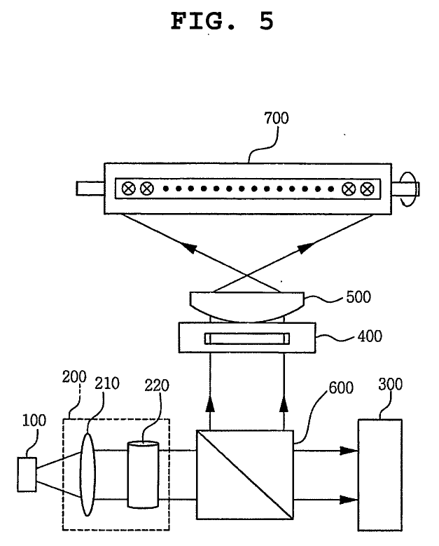

As shown in FIGS. 5 and 6, the scanning apparatus using a light modulator according to the present invention may further include a beam splitter 600 that transmits a collimated light type single beam incident through the first lens unit 200 to the light modulation means 300, and transmits a plurality of diffracted beams formed by the light modulation means 300 in the direction of the photosensitive member 700.

FIGS. 3 and 5 illustrate the construction of the scanning apparatus that performs one-dimensional horizontal scanning onto the photosensitive member 700 using the light modulation means 300 including actuating cells 310 arranged in one dimension.

Further, FIGS. 4 and 6 illustrate the construction of the scanning apparatus that performs two-dimensional horizontal scanning onto the photosensitive member 700 using the light modulation means 300 including actuating cells 310 arranged in two dimensions.

The light source 100 includes a single light emitting source implemented with a laser diode having a predetermined wavelength. Light emitted from the light source 100 is converted into linear light parallel to the direction of an optical path by the first lens unit 200, which will be described later. The parallel linear light is incident on the light modulation means 300 placed parallel to the optical path direction.

The first lens unit 200 functions to convert a single beam emitted from the light source 100 into linear light parallel to the optical path direction and to focus the linear light onto the light modulation means 300, and includes a collimator lens 210 and a cylindrical lens 220.

The collimator lens 210 converts spherical light incident from the light source 100 into collimated light, and allows the collimated light to be incident on the cylindrical lens 220.

In order to allow the collimated light incident from the collimator lens 210 to be horizontally incident on the light modulation means 300 that is placed parallel to the optical path direction, the cylindrical lens 220 converts the collimated light into parallel linear light.

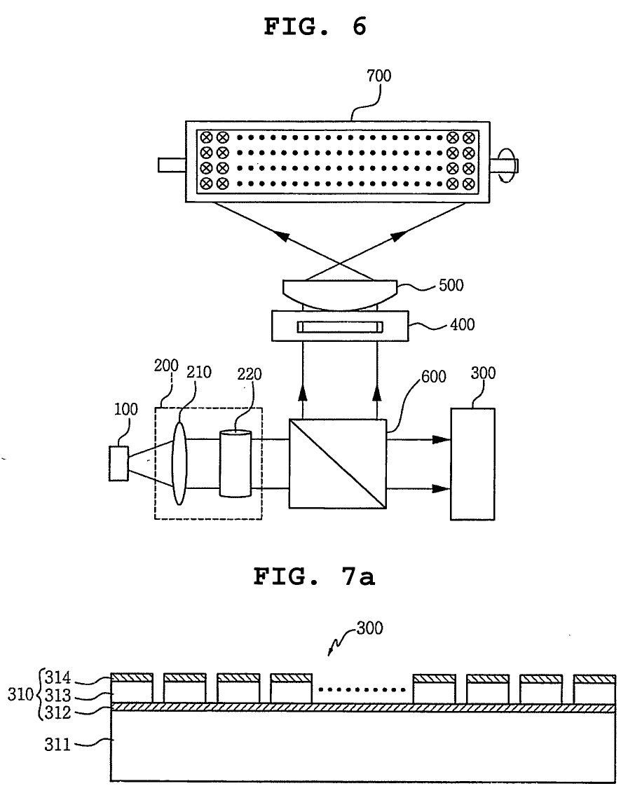

The light modulation means 300 forms a plurality of diffracted beams by diffracting the linear light type single beam incident from the first lens unit 200, and simultaneously and horizontally scans the diffracted beams onto the photosensitive member 700. As shown in FIGS. 7a and 7b, the light modulation means 300 includes a plurality of actuating cells 310 that are turned on/off by drive power to diffract and modulate incident linear light.

In this case, as shown in FIG. 7a, each of the actuating cells 310 constituting the light modulation means 300 applied to the present invention includes a lower electrode layer 312, a piezoelectric/electrostrictive layer 313 and an upper electrode layer 314 sequentially formed on a base substrate 311, and is attached to the base substrate 311.

Further, as shown in FIG. 7b, each of the actuating cells 310 constituting the light modulation means 300 applied to the present invention includes a lower electrode layer 312, a piezoelectric/electrostrictive layer 313 and an upper electrode layer 314 sequentially formed on a base substrate 311, and is spaced apart from the base substrate 311.

In this case, the lower electrode layer 312 formed on the base substrate 311 functions to receive drive power from an external power source and provide the drive power to the piezoelectric/electrostrictive layer 313, and is formed through a sputtering or evaporation method using an electrode material, such as Pt, Ta/Pt, Ti/Pt, I₂O₂, Ni, Au, Al, or RuO2.

The piezoelectric/electrostrictive layer 313 is interposed between the lower electrode layer 312 and the upper electrode layer 314, which will be described later. Further, the piezoelectric/electrostrictive layer 313 is contracted or expanded in response to the drive power, applied through the lower and upper electrode layers 312 and 314, to be vertically or horizontally varied, thus varying each actuating cell 310. In detail, the piezoelectric/electrostrictive layer 313 is made of a piezoelectric material, such as PZT, PLZT, AIN, PNN-PT, ZnO, Pb, Zr or titanium.

In this case, the piezoelectric/electrostrictive layer 313 is formed on the lower electrode layer 312 in a thickness range of 0.01 to 20.0 μm by applying a wet-type method (screen printing, Sol-Gel coating, etc.) or a dry-type method (sputtering, evaporation, vapor deposition, Chemical Vapor Deposition (CVD), etc.) to the piezoelectric material.

The upper electrode layer 314 functions to provide externally applied drive power to the piezoelectric/electrostrictive layer 313 together with the lower electrode layer 312, and is formed on the piezoelectric/electrostrictive layer 313 by applying a sputtering or evaporation process to an electrode material, such as Pt, Ti/Pt, Ta/Pt, Ni, Au, Al or RuO2.

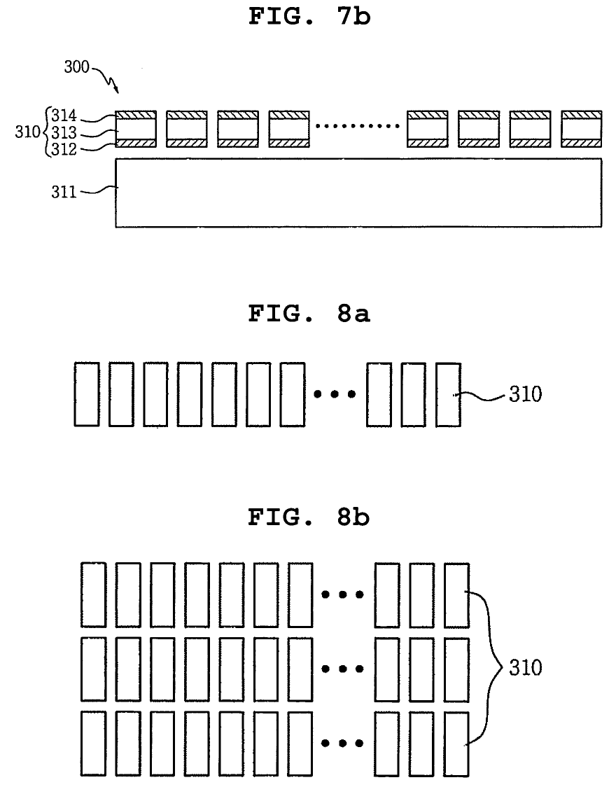

In this case, as shown in FIG. 8a, the light modulation means 300 applied to the present invention includes a plurality of actuating cells 310 arranged in one dimension, so that it horizontally scans a plurality of diffracted beams onto the photosensitive member 700 in one dimension, thus simultaneously performing one-dimensional scanning.

Further, as shown in FIG. 8b, the light modulation means 300 includes a plurality of actuating cells 310 arranged in two dimensions, so that it scans a plurality of diffracted beams onto a photosensitive surface in two dimensions, thus simultaneously performing two-dimensional scanning.

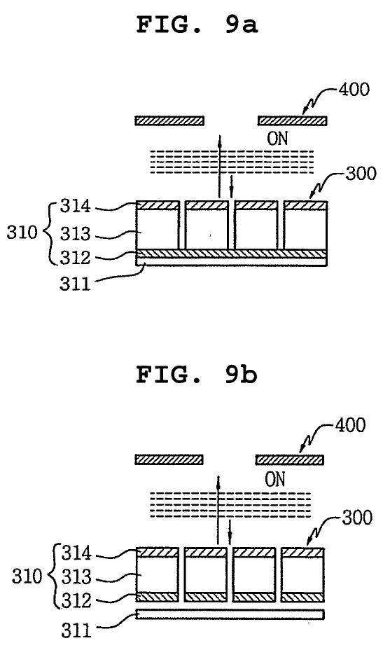

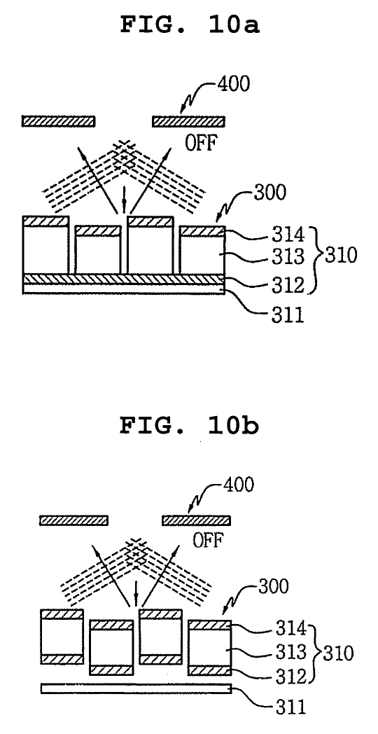

Hereinafter, the operation of the light modulation means applied to the present invention is described with reference to FIGS. 9 and 10.

In the light modulation means 300, step height is formed between neighboring actuating cells 310 by externally applied drive power, and the single beam incident through the first lens unit 200 is diffracted due to the step height to form a plurality of diffracted beams. The light modulation means 300 acts as a reflector for reflecting incident light according to the existence of externally applied drive power, or acts as a variable diffraction grating for generating diffracted beams having 0th, +1st and −1st order diffraction coefficients.

As shown in FIGS. 9a and 9b, if a collimated light type single beam is incident through the first lens unit 200 in a condition where the drive power is not externally applied, the actuating cells 310 constituting the light modulation means 300 do not cause diffraction because step height is not formed between the actuating cells 310, so that the single beam is reflected in a direction equal to its incident direction and then a 0th order diffracted beam is formed.

However, as shown in FIGS. 10a and 10b, if the collimated light type single beam is incident through the first lens unit 200 in a condition where the drive power is applied, the actuating cells 310, constituting the light modulation means 300, form step height therebetween, and diffract the single beam according to the step height, thus generating diffracted beams having 0th, +1st and −1st order diffraction coefficients.

In this case, step heights between the actuating cells 310, constituting the light modulation means 300, are formed to be ¼ of the wavelength of the collimated light type single beam incident through the first lens unit 200.

Further, the level of step heights formed between the actuating cells 310 constituting the light modulation means 300 is controlled by the strength of the drive power applied from an external power source, thus controlling printing strength.

That is, if the externally applied drive power is a high voltage, the piezoelectric/electrostrictive layer 313 forming each thick film shaped actuating cell 310 shown in FIG. 10a is greatly expanded upward or downward due to a piezoelectric phenomenon, thus increasing the printing strength of characters printed on a printing paper.

However, if the externally applied drive power is a low voltage, the piezoelectric/electrostrictive material layer 313 forming the actuating cell 310 is slightly expanded upward or downward due to a piezoelectric phenomenon, thus decreasing the printing strength of characters printed on a printing paper.

In this case, the piezoelectric/electrostrictive layer 313 forming each thin film shaped actuating cell 310 shown in FIG. 10b moves upward or downward due to a piezoelectric phenomenon, thus controlling the printing strength of characters printed on a printing paper.

Therefore, the scanning apparatus of the present invention controls the step height between the actuating cells 310 by finely adjusting a drive voltage applied to the actuating cells 310 constituting the light modulation means 300, thus performing true grayscale control of adjusting the intensity of diffracted beams having 0th order and ±1st order diffraction coefficients in an analog manner.

The slit 400 functions to receive diffracted beams having 0th, +1st and −1st order diffraction coefficients from the light modulation means 300, and selectively allows only diffracted beams having predetermined diffraction coefficients to pass therethrough and to be transmitted to the second lens unit 500 according to preset filtering conditions.

The second lens unit 500, which is a projection lens in detail, functions to form spots by focusing the diffracted beams having predetermined diffraction coefficients incident through the slit 400 onto the photosensitive surface of the photosensitive member 700.

Hereinafter, with reference to FIGS. 3 to 6, the operation of the scanning apparatus using a light modulator according to the present invention is described in detail.

First, the single spherical beam emitted from the light source 100 is incident on the first lens unit 200 including the collimator lens 210 and the cylindrical lens 220 formed on an optical axis.

The single spherical beam incident on the first lens unit 200 is converted into collimated light type single beam by the collimator lens 210, and the collimated light type single beam is incident on the cylindrical lens 220.

At this time, in order to allow the collimated light type single beam to be horizontally incident on the light modulation means 300 placed on the same horizontal plane as the photosensitive member 700, the cylindrical lens 220 converts collimated light incident from the collimator lens 210 into parallel linear light, and focuses the parallel linear light onto the light modulation means 300.

As described above, if the single beam that is converted into parallel linear light by the first lens unit 200 is focused, the light modulation means 300 forms step heights between the actuating cells 310 according to the existence of applied drive power, thus forming a plurality of diffracted beams having 0th, +1st and 1st order diffraction coefficients.

That is, if external drive power is not applied, the actuating cells 310, constituting the light modulation means 300, do not form step heights therebetween and emit a diffracted beam having a 0th order diffraction coefficient, formed by performing 0th order diffraction for the single beam incident in the form of collimated light, in the direction of the photosensitive member 700.

Further, if external drive power is applied, the actuating cells 310, constituting the light modulation means 300, form step heights therebetween and emit diffracted beams having a +1st or 1st order diffraction coefficient, formed by performing diffraction for the single beam incident in the form of collimated light, in the direction of the photosensitive member 700.

At this time, as shown in FIGS. 8a and 8b, since the actuating cells 310, constituting the light modulation means 300, are arranged in one dimension or two dimensions, they can form one-dimensional or two-dimensional diffracted beams having a predetermined diffraction coefficient.

Further, the level of the step heights formed between the actuating cells 310 constituting the light modulating means 300 can be finely adjusted on the basis of the strength of applied drive power, thereby performing true grayscale control of adjusting the intensity of diffracted beams having 0th, +1st and −1st order diffraction coefficients in an analog manner.

As described above, if the diffracted beams having predetermined diffraction coefficients formed by the light modulation means 300 are incident on the slit 400, which is a filtering means, the slit 400 selectively allows only diffracted beams having predetermined diffraction coefficients to pass therethrough depending on preset filtering conditions, and to filter out diffracted beams having other diffraction coefficients.

That is, if the filtering conditions are preset so that only a diffracted beam having a 0th order diffraction coefficient, among the diffracted beams incident from the light modulation means 300, selectively passes through the slit 400, the filtering means 400 selectively allows only the diffracted beam having a 0th order diffraction coefficient, among the diffracted beams incident from the light modulation means 300, to pass therethrough, as shown in FIGS. 9a and 9b. Therefore, the scanning apparatus of the present invention is in an ON state in which spots are formed on the photosensitive surface of the photosensitive member 700.

However, as shown in FIGS. 10a and 10b, if a diffracted beam incident from the light modulation means 300 has a +1st or −1st order diffraction coefficient, the filtering means 300 filters out the diffracted beam having a +1st or −1st order diffraction coefficient, so that the scanning apparatus of the present invention is in an OFF state in which spots are not formed on the photosensitive surface of the photosensitive member 700.

At this time, if the filtering conditions of the filtering means 400 are preset so that only diffracted beams having ±1st order diffraction coefficients selectively pass through the slit 400, the scanning apparatus of the present invention filters out a diffracted beam having a 0th order diffraction coefficient and is in an OFF state, while it selectively allows diffracted beams having ±1st order diffraction coefficients to pass therethrough and is in an ON state.

As described above, if the diffracted beams selectively passing through the filtering means 400 are incident on the second lens unit 500, the second lens unit 500 horizontally scans the incident diffracted beams onto the photosensitive member 700 in one dimension or two dimensions, thus simultaneously scanning the diffracted beams onto the photosensitive member 700 along one line or a plurality of lines.

As described above, the present invention provides a scanning apparatus using a light modulator, which is advantageous in that it allows a plurality of diffracted beams, formed by actuating cells turned on/off in response to drive power, to be horizontally incident on a photosensitive member, so that one-dimensional or two-dimensional high speed scanning is performed, thus guaranteeing more reliable high speed scanning without requiring a polygon mirror and an f-θ lens.

Further, the present invention is advantageous in that it finely adjusts the level of step heights formed between neighboring actuating cells by adjusting a drive voltage applied to actuating cells constituting a light modulator, thus performing true grayscale control of adjusting the intensity of diffracted beams having predetermined diffraction coefficients in an analog manner.

Further, the present invention is advantageous in that it performs true grayscale control of adjusting the intensity of diffracted beams having predetermined diffraction coefficients in an analog manner, thus increasing light uniformity between diffracted beams and improving image uniformity on a photosensitive surface.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A scanning apparatus using a light modulator, comprising:
a first lens unit for converting a single beam, emitted from a light source, into collimated light, and emitting the collimated light;
light modulation means including a plurality of actuating cells turned on/off by drive power, the light modulation means diffracting and modulating the single beam to form a plurality of diffracted beams by on/off operation of the actuating cells;
filtering means for selectively allowing diffracted beams having at least one predetermined diffraction coefficient, among the plurality of diffracted beams formed by the light modulation means, to pass therethrough; and
a second lens unit for focusing the plurality of diffracted beams selectively passing through the filtering means onto a photosensitive member,
wherein the light modulation means is placed on the same horizontal plane as the photosensitive member to simultaneously and horizontally scan the plurality of diffracted beams onto the photosensitive member.

2. The scanning apparatus according to claim 1, further comprising a beam splitter for transmitting the single beam incident through the first lens unit in a direction of the light modulation means, and transmitting the plurality of diffracted beams formed by the light modulation means in a direction of the photosensitive member.

3. The scanning apparatus according to claim 1, wherein the first lens unit comprises:
a collimator lens for converting a single spherical beam incident from the light source into a single collimated beam; and
a cylindrical lens for converting the single collimated beam incident from the collimator lens into parallel linear light so as to allow the single collimated beam to be horizontally incident on the light modulation means.

4. The scanning apparatus according to claim 1, wherein the light modulation means is implemented so that the actuating cells turned on/off by the drive power are arranged in one dimension.

5. The scanning apparatus according to claim 4, wherein the light modulation means acts as a reflector for reflecting the single beam incident from the first lens unit when the drive power is not applied to the actuating cells.

6. The scanning apparatus according to claim 4, wherein the light modulation means acts as a variable diffraction grating for performing diffraction for the single beam by ON/OFF operation between the actuating cells when the drive power is applied to the actuating cells.

7. The scanning apparatus according to claim 4, wherein the actuating cells each comprise:
a lower electrode formed on a base substrate, on which a depression is formed to provide an air space on a central portion, and provided with a drive voltage;
a piezoelectric/electrostrictive layer formed on the lower electrode by evaporating and sputtering a predetermined piezoelectric/electrostrictive material, and vertically driven by the drive voltage applied from the lower electrode; and
an upper electrode formed on the piezoelectric/electrostrictive layer through evaporation and sputtering to reflect and diffract the incident single beam at the same time to apply externally applied drive power to the piezoelectric/electrostrictive layer as the drive voltage.

8. The scanning apparatus according to claim 1, wherein the light modulation means is implemented so that the actuating cells turned on/off by the drive power are arranged in two dimensions.

9. The scanning apparatus according to claim 8, wherein the light modulation means acts as a reflector for reflecting the single beam incident from the first lens unit when the drive power is not applied to the actuating cells.

10. The scanning apparatus according to claim 8, wherein the light modulation means acts as a variable diffraction grating for performing diffraction for the single beam by ON/OFF operation between the actuating cells when the drive power is applied to the actuating cells.

11. The scanning apparatus according to claim 8, wherein the actuating cells each comprise:
a lower electrode formed on a base substrate, on which a depression is formed to provide an air space on a central portion, and provided with a drive voltage;
a piezoelectric/electrostrictive layer formed on the lower electrode by evaporating and sputtering a predetermined piezoelectric/electrostrictive material, and vertically driven by the drive voltage applied from the lower electrode; and
an upper electrode formed on the piezoelectric/electrostrictive layer through evaporation and sputtering to reflect and diffract the incident single beam at the same time to apply externally applied drive power to the piezoelectric/electrostrictive layer as the drive voltage.

12. The scanning apparatus according to claim 1, wherein the light modulation means performs true grayscale control for the diffracted beams by adjusting level of step heights between the actuating cells according to strength of the drive power.

13. The scanning apparatus according to claim 1, wherein the filtering means is a slit for selectively allowing diffracted beams having predetermined diffraction coefficients, among the diffracted beams incident from the light modulation means, to pass therethrough.

14. The scanning apparatus according to claim 1, wherein the second lens unit is a projection lens for focusing the diffracted beams selectively incident from the filtering means onto the photosensitive member.
